(19) United States
(12) Patent Application Publication
(10) Pub. No.: US 2016/0322705 A1
(43) Pub. Date: Nov. 3, 2016

(54) ASSEMBLY-TYPE DUAL-BAND PRINTED ANTENNA

(71) Applicant: ARCADYAN TECHNOLOGY CORPORATION, Hsinchu City (TW)

(72) Inventors: CHIH-YUNG HUANG, Taichung County (TW); MIN-CHI WU, Hsinchu County (TW); KUO-CHANG LO, Miaoli County (TW)

(21) Appl. No.: 15/096,334

(22) Filed: Apr. 12, 2016

(30) Foreign Application Priority Data
Apr. 30, 2015 (TW) 104113963

(51) Int. Cl. H01Q 5/307; H01Q 1/24; H01Q 9/06

(52) U.S. Cl. CPC H01Q 5/307; H01Q 9/065; H01Q 1/243

(57) ABSTRACT

An assembly-type dual-band printed antenna may include a substrate, an antenna signal feed-in end, a first radiator, a substrate assembly and a second radiator. The antenna signal feed-in end may be disposed on the substrate. The first radiator may be disposed on the substrate and may be coupled to the antenna signal feed-in end. The substrate assembly may be installed on the substrate and may include a via hole. The second radiator may be disposed on the substrate assembly and may be coupled to the first radiator through the via hole.

### CROSS-REFERENCE TO RELATED APPLICATION

This application claims the benefit of Taiwan Patent Application No. 104113963, filed on Apr. 30, 2015, in the Taiwan Intellectual Property Office, the disclosure of which is incorporated herein in its entirety by reference.

### BACKGROUND OF THE INVENTION

1. Field of the Invention

The present invention generally relates to an antenna, in particular to a multi-band printed antenna having two or more operating frequency bands.

2. Description of the Related Art

With the advance of technology, various kinds of antennas have been developed to be applied to a variety of hand-held electronic devices, such as mobile phone and notebook computer, etc., or wireless transmission devices, such as access point (AP) and wireless network card, etc. The above electronic devices need to be of small size and easy to carry, so the multi-band antenna applied to these electronic devices should be compact, light, have good transmission performance and can be easily installed in these electronic devices. However, the conventional multi-band antennas still have a lot of shortcomings to be overcome.

For example, most of the conventional multi-band antennas usually have several radiators corresponding to different frequency bands respectively; however, the radiations of these different frequency bands will interfere with each other due to the limitations of its structure design; as a result, the performance of the antenna will decrease. Moreover, the frequency bands, bandwidths and impedance matching of the conventional multi-band antennas are hard to adjust, so the conventional multi-band antennas are inflexible in use/

Also, most of the conventional multi-band antennas usually adopt 3D structure design, which exactly improves the performance of the antennas; however, the antennas with 3D structure design usually need more space, which will limit the application of the antennas. Besides, the antennas with 3D structure design tend to be deformed by external force, so the antennas usually have high failure rate; furthermore, the antennas with 3D structure design also needs additional mold cost and assembly cost, so the overall cost of the antennas will significantly increase. Similarly, the frequency bands, bandwidths and impedance matching of the antennas with 3D structure design are hard to adjust.

Further, most of the conventional multi-band antennas should be connected to the system grounding areas; therefore, they should be installed at specific positions, or they cannot work normally, which will limit the application of the antennas.

Accordingly, it has become an important issue to provide a multi-band antenna in order to solve the problems that the conventional multi-band antennas have low performance, high cost, is inflexible in use, limited in application and tends to be damaged, etc.

### SUMMARY OF THE INVENTION

Therefore, it is a primary objective of the present invention to provide an assembly-type dual-band antenna to solve the problems that the conventional multi-band antenna has low performance, high cost, is inflexible in use, limited in application and tends to be damaged, etc.

To achieve the foregoing objective, the present invention provides an assembly-type dual-band printed antenna; the antenna may include a substrate, an antenna signal feed-in end, a first radiator, a substrate assembly and a second radiator. The antenna signal feed-in end may be disposed on the substrate. The first radiator may be disposed on the substrate and may be coupled to the antenna signal feed-in end. The substrate assembly may be installed on the substrate and may include a via hole. The second radiator may be disposed on the substrate assembly and may be coupled to the first radiator through the via hole.

In a preferred embodiment of the present invention, the assembly-type dual-band printed antenna may further include a RF signal feed-in area and a system grounding area, wherein the system grounding area may be disposed on the substrate; the RF signal feed-in area may be disposed on the substrate and may include a RF signal feed-in grounding end and a RF signal feed-in end; the RF signal feed-in grounding end may be coupled to the system grounding area and the RF signal feed-in end may be coupled to the antenna signal feed-in end.

In a preferred embodiment of the present invention, the first radiator may be disposed on one side of the substrate, and the substrate assembly may be disposed on the same side of the substrate.

In a preferred embodiment of the present invention, the first radiator may be disposed on one side of the substrate, and the substrate assembly may be disposed on the other side of the substrate.

In a preferred embodiment of the present invention, the first radiator's projection on the substrate may not overlap the second radiator's projection on the substrate.

In a preferred embodiment of the present invention, the assembly-type dual-band printed antenna may further include a first soldering area disposed on the substrate, wherein the first soldering area may be coupled to the first radiator, and the substrate assembly may be soldered on the first soldering area.

In a preferred embodiment of the present invention, the via hole may be connected to the first soldering area, whereby the second radiator may be coupled to the first radiator via the via hole and the first soldering area.

In a preferred embodiment of the present invention, the assembly-type dual-band printed antenna may further include a second soldering area disposed on the substrate, wherein the substrate assembly may be soldered on the second soldering area.

In a preferred embodiment of the present invention, the thickness of the substrate assembly may be larger than the thickness of the substrate.

In a preferred embodiment of the present invention, the current path of the first radiator may be shorter than the current path of the second radiator.

In a preferred embodiment of the present invention, the current path of the first radiator may be longer than the current path of the second radiator.

In a preferred embodiment of the present invention, the first radiator may be substantially rectangular and may extend toward a first direction.

In a preferred embodiment of the present invention, the second radiator may be substantially U-shaped.

In a preferred embodiment of the present invention, the second radiator may further include a first part, a second part and a third part; the first part may extend toward a second direction, and one end of the first part may include a first protrusion part; the second part may extend toward the first direction, and may include a second protrusion part and a widening extension part; the third part may extend toward a fourth direction; the first direction, the second direction and the fourth direction may be perpendicular to one another.

In a preferred embodiment of the present invention, the second part may be related to the bandwidth and the impedance matching of the second radiator.

To achieve the foregoing objective, the present invention further provides an assembly-type dual-band printed antenna; the antenna may include an antenna signal feed-in end, a first radiator and a second radiator. The first radiator may be coupled to the antenna signal feed-in end, wherein the current path of the first radiator may be on a first plane. The second radiator may be coupled to the first radiator via a via hole, wherein the current path of the second radiator may be on a second plane; the first plane may be substantially parallel to the second plane, and there may be a space between the first plane and the second plane.

In a preferred embodiment of the present invention, the current path of the first radiator may be shorter than a current path of the second radiator.

In a preferred embodiment of the present invention, the first radiator may be substantially rectangular and may extend toward a first direction.

In a preferred embodiment of the present invention, the second radiator may be substantially U-shaped.

In a preferred embodiment of the present invention, the second radiator may further include a first part, a second part and a third part; the first part may extend toward a second direction, and one end of the first part may include a first protrusion part; the second part may extend toward the first direction, and may include a second protrusion part and a widening extension part; the third part may extend toward a third direction; the first direction, the second direction and the third direction may be perpendicular to one another.

In a preferred embodiment of the present invention, the second part may be related to the bandwidth and the impedance matching of the second radiator.

The assembly-type dual-band antenna in accordance with the present invention has the following advantages:

(1) In one embodiment of the present invention, the antenna's two radiators corresponding to different frequency bands are disposed on different planes; besides, the two radiators are parallel to each other and there is a space between the two radiators; therefore, the radiations generated by the two radiators will not interfere with each other, which can significantly increase the performance of the antenna.

(2) In one embodiment of the present invention, one radiator of the antenna is printed on the substrate, and the other radiator of the antenna is printed on the substrate assembly; besides, the substrate assembly is fixed on the substrate by soldering, which can not only prevent the two radiators from being deformed and effectively reduce the failure rate of the antenna, but also can still achieve the effect of a 3D antenna; moreover, the size of the antenna is further reduced, so the antenna can have boarder prospect in application.

(3) In one embodiment of the present invention, the design concept of the present invention is realized by a printed antenna, so the mold cost and the assembly cost needed by a 3D antenna can be saved; for the reason, the overall cost of the antenna can be dramatically reduced, so the antenna can have high commercial value.

(4) In one embodiment of the present invention, the radiators are respectively disposed on different substrates, so the frequency bands, bandwidths and impedance matching of the two radiators can be respectively adjusted; thus, the antenna can be more flexible in use.

(5) In one embodiment of the present invention, the substrate assembly can be installed on the substrate by the automation-mount process without any manual operation; thus, the antenna is very easy in mass production.

(6) In one embodiment of the present invention, the structure design of the antenna allows the antenna to be installed at any positions of a device without being limited by the system grounding area; therefore, the antenna can be applied to most of electric devices.

### BRIEF DESCRIPTION OF THE DRAWINGS

The detailed structure, operating principle and effects of the present invention will now be described in more details hereinafter with reference to the accompanying drawings that show various embodiments of the invention as follows.

FIG. 1 is the first schematic view of the first embodiment of the assembly-type dual-band antenna in accordance with the present invention.

FIG. 2 is the second schematic view of the first embodiment of the assembly-type dual-band antenna in accordance with the present invention.

FIG. 3 is the third schematic view of the first embodiment of the assembly-type dual-band antenna in accordance with the present invention.

FIG. 4 is the fourth schematic view of the first embodiment of the assembly-type dual-band antenna in accordance with the present invention.

FIG. 5 is the fifth schematic view of the first embodiment of the assembly-type dual-band antenna in accordance with the present invention.

FIG. 6 is the sixth schematic view of the first embodiment of the assembly-type dual-band antenna in accordance with the present invention.

FIG. 7 is the seventh schematic view of the first embodiment of the assembly-type dual-band antenna in accordance with the present invention.

FIG. 8 is the return loss diagram of the first embodiment of the assembly-type dual-band antenna in accordance with the present invention.

FIG. 9 is the antenna efficiency diagram of the first embodiment of the assembly-type dual-band antenna in accordance with the present invention.

FIG. 10 is the schematic view of the second embodiment of the assembly-type dual-band antenna in accordance with the present invention.

### DETAILED DESCRIPTION OF THE PREFERRED EMBODIMENTS

The technical content of the present invention will become apparent by the detailed description of the following embodiments and the illustration of related drawings as follows.

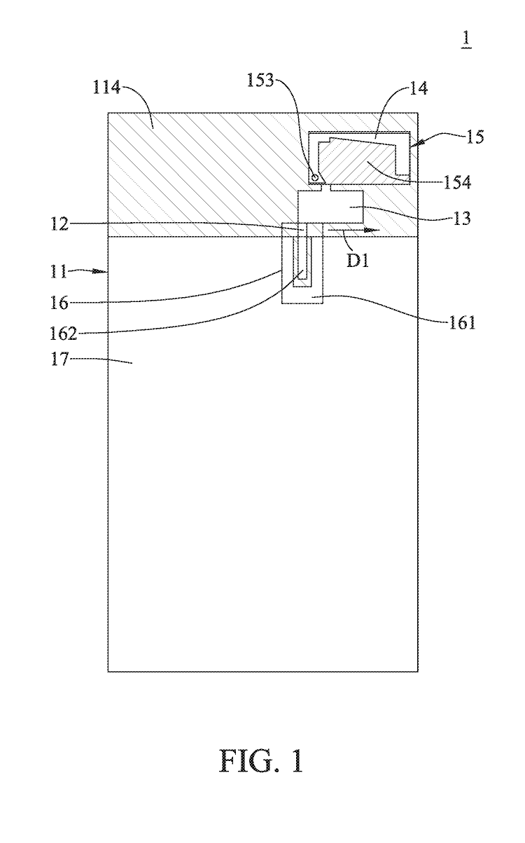

Please refer to FIG. 1, which is the first schematic view of the first embodiment of the assembly-type dual-band antenna in accordance with the present invention; the embodiment realizes the concept of the present invention by a printed antenna. As shown in FIG. 1, the assembly-type dual-band antenna 1 may include a substrate 11, an antenna signal feed-in end 12, a first radiator 13, a substrate assembly 15, a second radiator 14, a RF signal feed-in area 16 and a system grounding area 17.

The antenna signal feed-in end 12 may be disposed on the substrate 11. The first radiator 13 may be substantially rectangular and extend toward the first direction D1, wherein the first radiator 13 may be printed on the substrate 11 and coupled to the antenna signal feed-in end 12. The substrate assembly 15 can be installed on the substrate 11; besides, the substrate assembly 15 may include a via hole 153. The second radiator 14 may be substantially U-shaped, wherein the second radiator 14 may be printed on the substrate assembly 15 and coupled to the first radiator 13 via the via hole 153. The RF signal feed-in area 16 may be disposed on the substrate 11 and may include a RF signal feed-in end 161 and a RF signal feed-in end 162, wherein the RF signal feed-in end 161 may be coupled to the system grounding area 17 and the RF signal feed-in end 162 may be coupled to the antenna signal feed-in end 12. In a preferred embodiment, the thickness of the substrate assembly 15 may be larger than the thickness of the substrate 11; more specifically, the thickness of the substrate 11 may be about 3 mm, and the thickness of the substrate assembly 15 may be about 2-6 mm.

As described above, in the embodiment, the first radiator 13 and the second radiator 14 may be respectively printed on the substrate 11 and the substrate assembly 15, such that the current path of the first radiator 13 and the current path of the second radiator 14 are on different planes; besides, the two planes are substantially parallel to each other and there is a space between the two planes. In this way, the radiations generated by the two radiators will not interfere with each other, so the performance of the assembly-type dual-band printed antenna 1 can be significantly improved.

Moreover, the above structure can also effectively prevent the two radiators from being deformed, which can not only effectively decrease the failure rate of the antenna and but also can achieve the effect of a 3D antenna and reduce; thus, the application of the antenna can be more comprehensive.

In other preferred embodiments, the substrate assembly 15 may be disposed on the other side of the substrate 11; in other words, the substrate assembly 15 may be disposed on the side opposite to the first radiator 13; besides, the first radiator 13′s projection on the substrate 11 does not overlap the second radiator 14′s projection on the substrate 11. The above structure can increase the distance between the first radiator 13 and the second radiator 14 to further prevent the two radiations generated by the two radiators 13, 14 from interfering with each other and further increase the performance of the assembly-type dual-bank printed antenna 1.

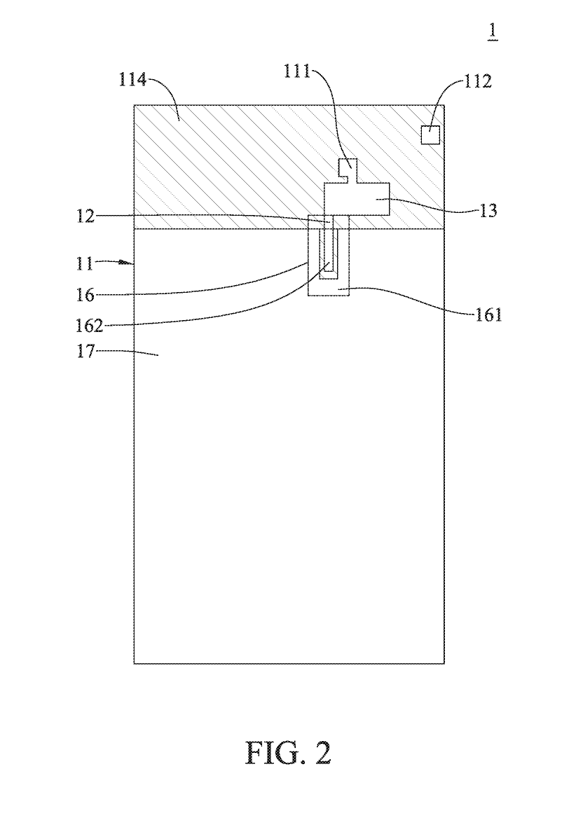

Please refer to FIG. 2, which is the second schematic view of the first embodiment of the assembly-type dual-band antenna in accordance with the present invention; FIG. 2 is the front view of the substrate 11. As shown in FIG. 2, the substrate 11 may further include the first soldering area 111 and the second soldering area 112, wherein the first soldering area 111 may be disposed on the position corresponding to the via hole 153 of the substrate assembly 15 and may be coupled to the first radiator 13.

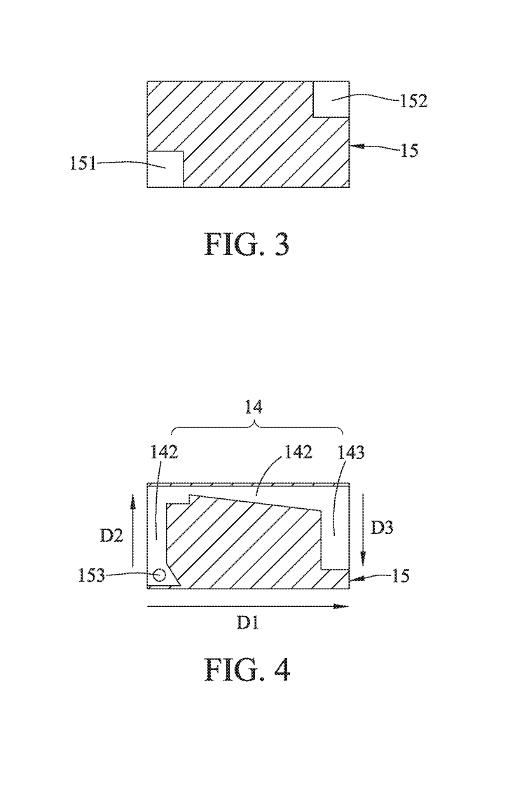

Please refer to FIG. 3, which is the third schematic view of the first embodiment of the assembly-type dual-band antenna in accordance with the present invention; FIG. 3 is the rear view of the substrate assembly 15. As shown in FIG. 3, the rear of the substrate assembly 15 may further include the third soldering area 151 and the fourth soldering area 152, wherein the third soldering area 151 and the fourth soldering area 152 may be respectively corresponding to the first soldering area 111 and the second soldering area 112. Thus, the third soldering area 151 and the fourth soldering area 152 may be respectively soldered on the first soldering area 111 and the second soldering area 112; in this way, the substrate assembly 15 may be installed on the substrate 11, and the second radiator 14 can be coupled to the first radiator 13 via the via hole 153.

Please refer to FIG. 4, which is the fourth schematic view of the first embodiment of the assembly-type dual-band antenna in accordance with the present invention; FIG. 4 is the front view of the substrate assembly 15. As shown in FIG. 4, the second radiator 14 may be substantially U-shaped, and may include a first part 141, a second part 142 and a third part 143. The first part 141 may extend toward the second direction D2 and one end of the first part 141 may include a first protrusion part. The second part 142 may extend toward the first direction D1 and may include a second protrusion part and a widening extension part. The third part 143 may extend toward the third direction D3, wherein the first direction D1, the second direction D2 and the third direction D3 may be perpendicular to one another. More specifically, the structure of the second part 142 is related to the bandwidth and the impedance matching of the second radiator 14, so it is possible to modify the structure of the second part 142 of the second radiator 14 to change the bandwidth and the impedance matching of the second radiator 14 according to different requirements.

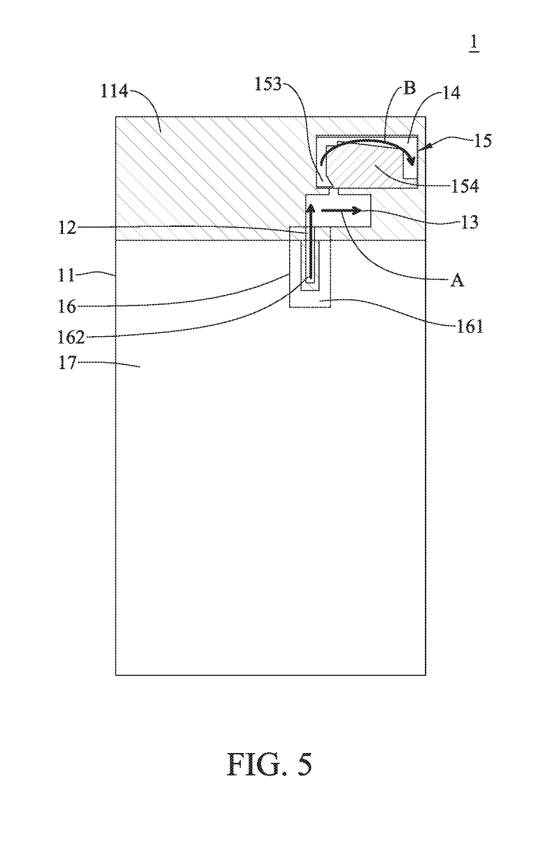

Please refer to FIG. 5, which is the fifth schematic view of the first embodiment of the assembly-type dual-band antenna in accordance with the present invention; FIG. 5 illustrates the current paths of the first radiator 13 and the second radiator 14. As shown in FIG. 5, the current path A of the first radiator 13 may be shorter than the current path B of the second radiator 14, such that the operating frequency band of the first radiator 13 may be higher than the operating frequency band of the second radiator 14. Thus, the lengths of the first radiator 13 and the second radiator 14 can be changed to adjust their operating frequency bands according to different requirements. Via the above structure, the operating frequency bands, bandwidths and the impedance matching of the first radiator 13 and the second radiator 14 are easy to adjust, so the antenna can meet most requirements. However, the above structure is just for example rather than limitation; the assembly-type dual-band printed antenna can be also realized by other structures.

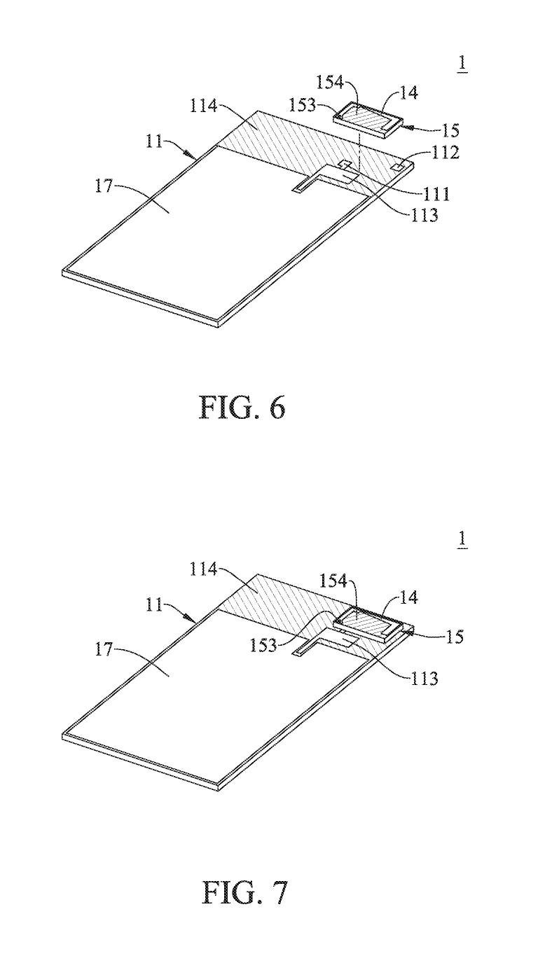

Please refer to FIG. 6 and FIG. 7, which are the sixth schematic view and the seventh schematic view of the first embodiment of the assembly-type dual-band antenna in accordance with the present invention; FIG. 6 and FIG. 7 illustrate the assembly-type dual-band printed antenna 1 before and after the substrate assembly 15 is installed on the substrate 11. As shown in FIG. 6 and FIG. 7, the third soldering area 151 and the fourth soldering area 152 of the substrate assembly 15 can be respectively soldered on the first soldering area 111 and the second soldering area 112 of the substrate 11, such that the substrate assembly 15 can be installed on the substrate 11. By means of the structure, the substrate assembly 15 can be installed on the substrate 11 by the automation-mount process without any manual operation; thus, the antenna is very easy in mass production.

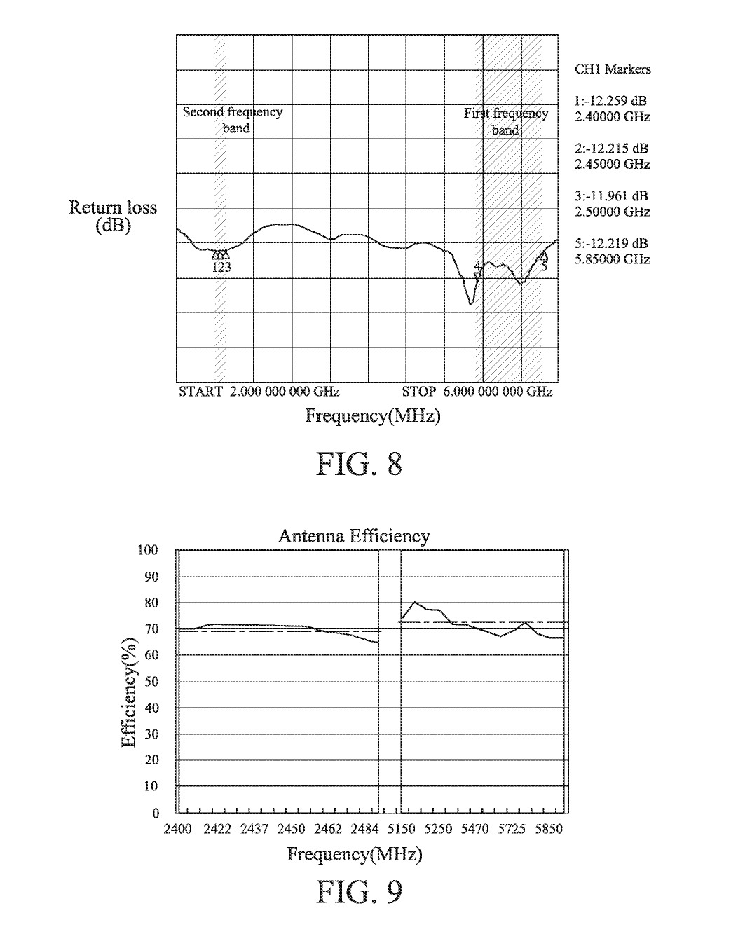

Please refer to FIG. 8, which is the return loss diagram of the first embodiment of the assembly-type dual-band antenna in accordance with the present invention; FIG. 8 illustrates the return loss (RL) of the assembly-type dual-band printed antenna 1 of the embodiment, wherein the operating frequency band of the first radiator 13 is the first frequency band and the operating frequency band of the second radiator 14 is the second frequency band. As shown in FIG. 8, the return losses of the first radiator 13 and the second radiator 14 conform to the standard of the industry.

Please refer to FIG. 9, which is the antenna efficiency diagram of the first embodiment of the assembly-type dual-band antenna in accordance with the present invention; FIG. 9 illustrates the efficiency of the assembly-type dual-band printed antenna 1, wherein the operating frequency band of the first radiator 13 is the first frequency band and the operating frequency band of the second radiator 14 is the second frequency band. As shown in FIG. 9, the average efficiency of the first radiator 13 is about 72.1%; and the average efficiency of the second radiator 14 is about 69.9%; therefore, both radiators 13, 14 can achieve high efficiency and conform to the standard of the industry.

It is worthy to note that most of the conventional multi-band antenna usually have several radiators respectively corresponding to different operating frequency bands, and the radiations generated by different operating frequency bands tend to interfere with each other, which will significantly decrease the performance of the antenna; on the contrary, in the embodiment, the two radiators corresponding to different operating frequency bands are disposed on different planes; besides, the two radiators are parallel to each other and there is a space between the two radiators; as a result, the radiations generated by the two radiators will not interfere with each other, so the performance of the antenna can be significantly improved.

Also, most of the conventional multi-band antennas adopts 3D structure design, which occupies more space; besides, the antennas with 3D structure design tend to be deformed by external force, and need additional mold cost and assembly cost. On the contrary, in one embodiment of the present invention, one radiator can be printed on the substrate and the other radiator can be printed on the substrate assembly; besides, the substrate assembly can be soldered on the substrate, which can save the mold cost and the assembly cost needed by the 3D antenna, so the cost of the antenna can be reduced; further, the above structure can effectively prevent the two radiators from being deformed by external force, so the failure rate of the antenna can be decreased but still can achieve the effect of the 3D antenna; therefore, the application of the antenna can be more comprehensive.

Moreover, the operating frequency bands, bandwidths and impedance matching of most of the conventional multi-band antennas are hard to adjust, so they are very inflexible in use. On the contrary, in one embodiment of the present invention, the two radiators of the antenna are respectively disposed on different substrates, so the operating frequency bands, bandwidths and impedance matching of the two radiator can be respectively adjusted according to the requirements, which significantly increase the antenna's flexibility in use.

Furthermore, as most of the conventional multi-band antenna should be connected to the system grounding area of the device, so they can be installed at specific positions of the device. On the contrary, in one embodiment of the present invention, the structure design of the antenna allows the antenna to be install at any positions of the device without being limited by the system grounding area; therefore, the antenna can be applied to most electronic devices. As described above, the assembly-type dual-band printed antenna definitely has an inventive step.

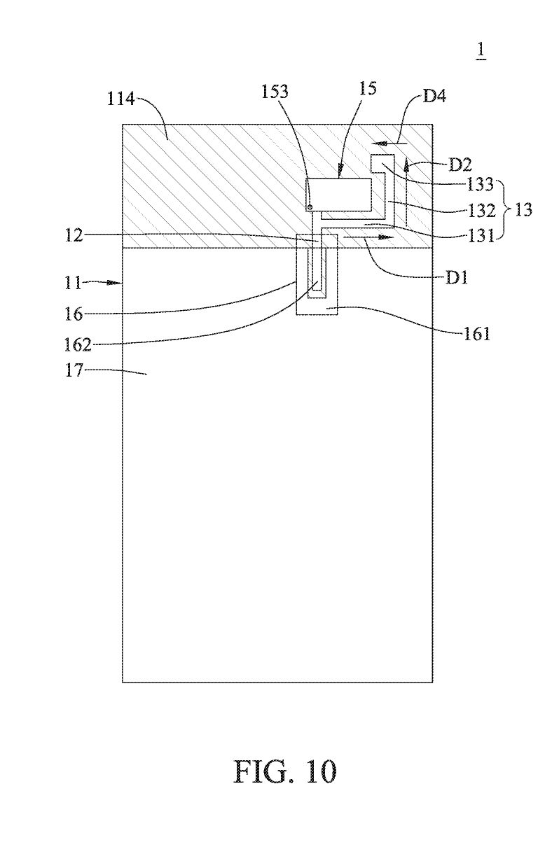

Please refer to FIG. 10, which is the schematic view of the second embodiment of the assembly-type dual-band antenna in accordance with the present invention; as shown in FIG. 10, the assembly-type dual-band antenna 1 may include a substrate 11, an antenna signal feed-in end 12, a first radiator 13, a substrate assembly 15, a second radiator 14, a RF signal feed-in area 16 and a system grounding area 17.

The antenna signal feed-in end 12 may be disposed on the substrate 11. The first radiator 13 may be substantially U-shaped, wherein the first radiator 13 may be printed on the substrate 11 and coupled to the antenna signal feed-in end 12. The substrate assembly 15 can be installed on the substrate 11; besides, the substrate assembly 15 may include a via hole 153. The second radiator 14 may be substantially rectangular, wherein the second radiator 14 may be printed on the substrate assembly 15 and coupled to the first radiator 13 via the via hole 153. The RF signal feed-in area 16 may be disposed on the substrate 11 and may include a RF signal feed-in end 161 and a RF signal feed-in end 162, wherein the RF signal feed-in end 161 may be coupled to the system grounding area 17 and the RF signal feed-in end 162 may be coupled to the antenna signal feed-in end 12.

The difference between the embodiment and the previous embodiment is that the first radiator 13 may be substantially U-shaped, and may include a first part 131, a second part 132 and a third part 133. The first part 131 may extend toward the first direction D1; the second part 132 may extend toward the second direction D2; the third part 133 may extend toward the fourth direction D4, wherein the first direction D1, the second direction D2 and the fourth direction D4 may be perpendicular to one another. The first radiator 13 has a longer current path, so the first radiator 13 can be operated under lower operating frequency; the second radiator 14 is substantially rectangular and can extend toward the first direction D1, so the second radiator 14 has a shorter current path and can be operated under higher operating frequency. As described above, the assembly-type dual-band printed antenna 1 can still achieve the same effect and provide excellent performance even if the current paths of the two radiators 13, 14 of the antenna 1 are exchanged with each other.

In summation of the description above, in one embodiment of the present invention, the antenna's two radiators corresponding to different frequency bands are disposed on different planes; besides, the two radiators are parallel to each other and there is a space between the two radiators; therefore, the radiations generated by the two radiators will not interfere with each other, which can significantly increase the performance of the antenna.

In one embodiment of the present invention, one radiator of the antenna is printed on the substrate, and the other radiator of the antenna is printed on the substrate assembly; besides, the substrate assembly is soldered on the substrate, which can not only prevent the two radiators from being deformed and effectively reduce the failure rate of the antenna, but also can still achieve the effect of a 3D antenna; moreover, the size of the antenna is further reduced, so the antenna can have boarder prospect in application.

In one embodiment of the present invention, the design concept of the present invention is realized by a printed antenna, so the mold cost and the assembly cost needed by a 3D antenna can be saved; for the reason, the overall cost of the antenna can be dramatically reduced, so the antenna can have high commercial value.

Besides, in one embodiment of the present invention, the radiators are respectively disposed on different substrates, so the frequency bands, bandwidths and impedance matching of the two radiators can be respectively adjusted; thus, the antenna can be more flexible in use.

Moreover, in one embodiment of the present invention, the substrate assembly can be installed on the substrate by the automation-mount process without any manual operation; thus, the antenna is very easy in mass production.

Furthermore, in one embodiment of the present invention, the structure design of the antenna allows the antenna to be installed at any positions of a device without being limited by the system grounding area; therefore, the antenna can be applied to most of electric devices.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. A antenna, comprising:
a substrate;
an antenna signal feed-in end, being disposed on the substrate;
a first radiator, being disposed on the substrate and coupled to the antenna signal feed-in end;
a substrate assembly, being installed on the substrate and comprising a via hole; and
a second radiator, being disposed on the substrate assembly and coupled to the first radiator through the via hole.

2. The antenna of claim 1, further comprising a RF signal feed-in area and a system grounding area, wherein the system grounding area is disposed on the substrate; the RF signal feed-in area is disposed on the substrate and comprises a RF signal feed-in grounding end and a RF signal feed-in end; the RF signal feed-in grounding end is coupled to the system grounding area and the RF signal feed-in end is coupled to the antenna signal feed-in end.

3. The antenna of claim 1, wherein the first radiator is disposed on one side of the substrate, and the substrate assembly is disposed on the same side of the substrate.

4. The antenna of claim 1, wherein the first radiator is disposed on one side of the substrate, and the substrate assembly is disposed on the other side of the substrate.

5. The antenna of claim 4, wherein the first radiator's projection on the substrate does not overlap the second radiator's projection on the substrate.

6. The antenna of claim 1, further comprising a first soldering area disposed on the substrate, wherein the first soldering area is coupled to the first radiator, and the substrate assembly is soldered on the first soldering area.

7. The antenna of claim 6, wherein the via hole is connected to the first soldering area, whereby the second radiator is coupled to the first radiator via the via hole and the first soldering area.

8. The antenna of claim 7, further comprising a second soldering area disposed on the substrate, wherein the substrate assembly is soldered on the second soldering area.

9. The antenna of claim 1, wherein a thickness of the substrate assembly is larger than a thickness of the substrate.

10. The antenna of claim 9, wherein a current path of the first radiator is shorter than a current path of the second radiator.

11. The antenna of claim 9, wherein a current path of the first radiator is longer than a current path of the second radiator.

12. The antenna of claim 10, wherein the first radiator is substantially rectangular and extends toward a first direction.

13. The antenna of claim 12, wherein the second radiator is substantially U-shaped.

14. The antenna of claim 13, wherein the second radiator further comprises a first part, a second part and a third part; the first part extends toward a second direction, and one end of the first part comprises a first protrusion part; the second part extends toward the first direction, and comprises a second protrusion part and a widening extension part; the third part extends toward a fourth direction; the first direction, the second direction and the fourth direction are perpendicular to one another.

15. The antenna of claim 14, wherein the second part is related to a bandwidth and an impedance matching of the second radiator.

16. A antenna, comprising:
an antenna signal feed-in end;
a first radiator, being coupled to the antenna signal feed-in end, wherein a current path of the first radiator is on a first plane; and
a second radiator, being coupled to the first radiator via a via hole, wherein a current path of the second radiator is on a second plane; the first plane is substantially parallel to the second plane, and there is a space between the first plane and the second plane.

17. The antenna of claim 16, wherein a current path of the first radiator is shorter than a current path of the second radiator.

18. The antenna of claim 17, wherein the first radiator is substantially rectangular and extends toward a first direction.

19. The antenna of claim 18, wherein the second radiator is substantially U-shaped.

20. The antenna of claim 19, wherein the second radiator further comprises a first part, a second part and a third part; the first part extends toward a second direction, and one end of the first part comprises a first protrusion part; the second part extends toward the first direction, and comprises a second protrusion part and a widening extension part; the third part extends toward a third direction; the first direction, the second direction and the third direction are perpendicular to one another.

21. The antenna of claim 20, wherein the second part is related to a bandwidth and an impedance matching of the second radiator.
